(19) United States
(12) Patent Application Publication
(10) Pub. No.: US 2009/0146947 A1
(43) Pub. Date: Jun. 11, 2009

(54) UNIVERSAL WEARABLE INPUT AND AUTHENTICATION DEVICE

(76) Inventor: James Ng, Seattle, WA (US)

Correspondence Address: CLOUTIER & ENGLE, PLLC;ATTN: PRIYA SINHA CLOUTIER, 320 DAYTON STREET, SUITE 260, EDMONDS, WA, 98020, US

(21) Appl. No.: 11/952,877

(22) Filed: Dec. 7, 2007

(51) Int. Cl. G09G 5/00

(52) U.S. Cl. 345/156

(57) ABSTRACT

The object of the wearable input device is to provide the user with one data input device and authentication system that is portable and can be worn like a fashion accessory, such as a watch or bracelet, so as to be unobtrusive to daily activity. The wearable input device can be used to replace home and car lock and security systems, television/VCR/DVD remote controls, personal computer authentication system, credit card authentication systems, automatic teller machine authentication systems, among others.

### CROSS-REFERENCES TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND

On a daily basis, most modern men interface with multiple electronic systems such as personal computers, personal digital media devices, cell phones, and PDAs, among others. Each electronic system has a different password or other authentication system requiring modern man to remember a multitude of information that can be easily lost or stolen. The amount of information modern man is required to remember increases substantially when one accounts for the passwords and/or usernames needed to use applications, including but not limited to web sites, which are run on the electronic systems.

Passwords are limited in length and content by what a user can remember. Additionally, conventional authentication systems are easily infiltrated because both the authentication code and password may be stored within the electronic system. Consequently, if a laptop, for example, is stolen, the data stored within is easily accessible.

Portable electronic systems such as iPods, cell phones, and PDAs have very small input devices. Persons with large fingers have a difficult time inputting data on such devices. Many portable systems now have a keyboard that can be attached to portable devices. However, these keyboards must be carried separately and are often as small as the input device on the portable electronic system.

With so many types of electronic systems, both portable and not, there are a multitude of input devices taking up room in homes, office, brief cases, and cars. Additionally, these input devices do not address the needs of the disabled person who may be unable to use his fingers to operate a keyboard.

Information relevant to attempts to address these problems can be found in Fukumoto et. al., U.S. Pat. No. 6,380,923; Yoon et. al., U.S. Pat. No. 7,012,593; and Grimes, U.S. Pat. No. 4,414,537; Daniel, U.S. Pat. No. 7,161,579. However, each of these references suffers from one or more of the following disadvantages:

(1) does not address the problems presented by conventional authentication systems;
(2) does not provide an input device that is unobtrusive to daily activity;
(3) does not provide for an universal input device; and
(4) does not provide for an input device that can be used by an individual who may not be able to use his fingers.

The object of the wearable input device is to provide the user with one data input device and authentication system that is portable and can be worn like a fashion accessory, much like a watch or bracelet, and will be unobtrusive during daily activity. The wearable input device can be used to replace home and car lock and security systems, television/VCR/DVD remote controls, personal computer authentication systems, credit card authentication systems, and automatic teller machine authentication systems, among others.

While preferred embodiments of the invention will be shown and described, it will be obvious to those skilled in the art that changes and modifications maybe made therein without departing from the invention in its broader aspects. For example, although in the preferred embodiment, the wearable input device is worn on the wrist, it can be worn on other parts of the body where the user has control over movement. For illustrative purposes henceforth.

The wearable input device is biometric type device. In its preferred embodiment, the wearable input device is calibrated to the movement of the user's wrist. Once calibrated to the user, the wearable input device will respond only to that calibrated user, creating a layer of security which is dependent on something as unique an individual's fingerprint. Once the wearable input device is calibrated to a particular user, the user must log on to the wearable input device using a movement or series of movements each time the wearable input device is turned on.

The wearable input device provides the user with an authentication system that is more secure than conventional systems found on most electronic systems. Once authentication data is stored in the wearable input device, it never needs to be accessed again by the user. The wearable input device will authenticate data from an electronic system via a wireless communication system. Because the user is no longer required to remember passwords, the password string can be longer, encrypted and/or random. With regard to websites using the wearable input device authentication system, the wearable input device can automatically negotiate a username and/or password.

Because the wearable input device operates when it senses movement or patterns of movements, the wearable input device can be worn on any part of the user's body where he can control movement. Consequently, it is not necessary for the user to move his fingers to manipulate keyboard or cursor input. However, because finger movement causes movement on the wrist, both finger and wrist movement can be used to manipulate keyboard or cursor input. Cursor input can be made by making a movement or pattern or movements. Cursor input can also be made by configuring a plurality of sensors arranged in a configuration that allows for calculation of position by triangulation. The relative position of the wearable input device to the receiving sensor can be calculated and mapped to a computer sensor allowing the user of the wearable input device to control a screen cursor.

### BRIEF SUMMARY OF THE INVENTION

The present invention is directed to a wearable input device that allows the user to control electronic systems by movements made by his body; movements that are as unique as fingerprints. The wearable input device comprises an array of sensors that will detect either pressure or electrical changes caused by the movement caused by the user's body. The pressure or electrical changes will allow the user to wirelessly control cursors and data input on electronic systems; and receives and/or sends and verifies authentication data from/to electronic systems. The electronic systems can be, for example, personal computers, personal digital media devices, cell phones, PDAs, among others.

### BRIEF DESCRIPTION OF THE SEVERAL VIEWS OF THE DRAWINGS

Other features and advantages of the present invention will become apparent in the following detailed descriptions of the preferred embodiment with reference to the accompanying drawings, of which:

FIG. 1: Wearable input device shown in its preferred embodiment;

FIG. 2: Flow chart of conventional authentication system;

FIG. 3: Flow chart of wearable input system mapping movement to cursor or keyboard of an electronic system;

### DETAILED DESCRIPTION OF THE INVENTION

In the following description, the term electronic system(s) is used to describe systems such as personal computers, personal digital media devices, cell phones, PDAs, among others. This list is not exclusive. The wearable input device has a plurality of applications including, but not limited to, (a) authentication of electronic systems and applications; and (b) cursor control and data input. These applications will be discussed in turn below.

In the preferred embodiment the wearable input device is worn on at least one wrist, however, the wearable input device can be worn on other parts of the body where the user has control over movement.

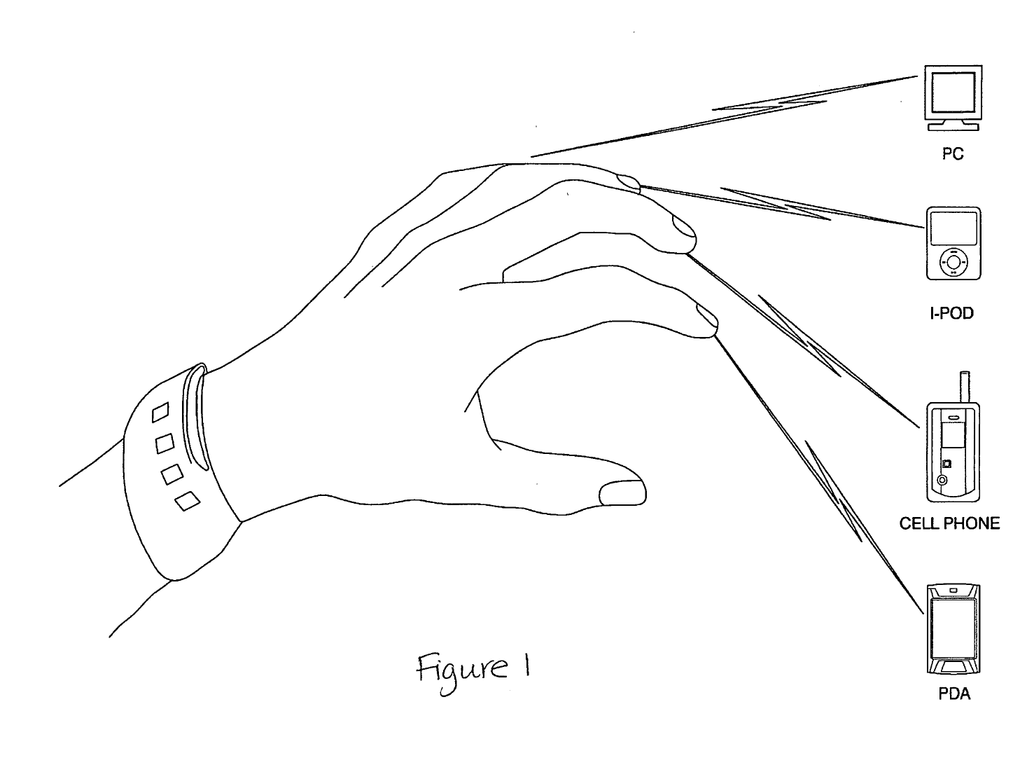

The wearable input device, shown in FIG. 1, in its preferred embodiment, will be worn as a watch or bracelet and is adjustable to the size of the user's wrist. Integral to the wearable input device is at least one array of pressure or electrical sensors, not shown, that will be used to calibrate the wearable input device to the user and sense a pre-determined movement or set of movements.

Pre-determined user movement or set of movements will enable one or two way communication, utilizing wireless protocols, between the wearable input device and the electronic system. Some electronic systems, for example the iPod, will request communication once the electronic system is turned on. When an electronic system requests communication, the user of the wearable input device will allow communication by making a movement or pattern of movements. This function will prevent the user of the wearable input device from inadvertently taking action on the iPod, for example, when simultaneously working with several electronic systems.

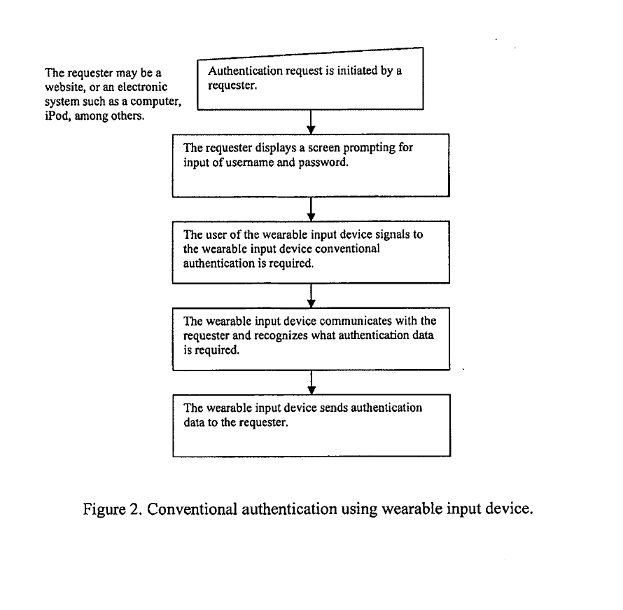

The wearable input device has a means to authenticate both electronic systems, electronic system applications, and websites among others. In the preferred embodiment, the wearable input device will require the user to make a movement or pattern of movements to initiate authentication or allow authentication when requested by an electronic system. Similarly, the wearable input device can also be used to authenticate electronic system applications or internet applications. The wearable input device can be used to authenticate any conventional authentication system. FIG. 2 is a flow chart showing a conventional authentication method.

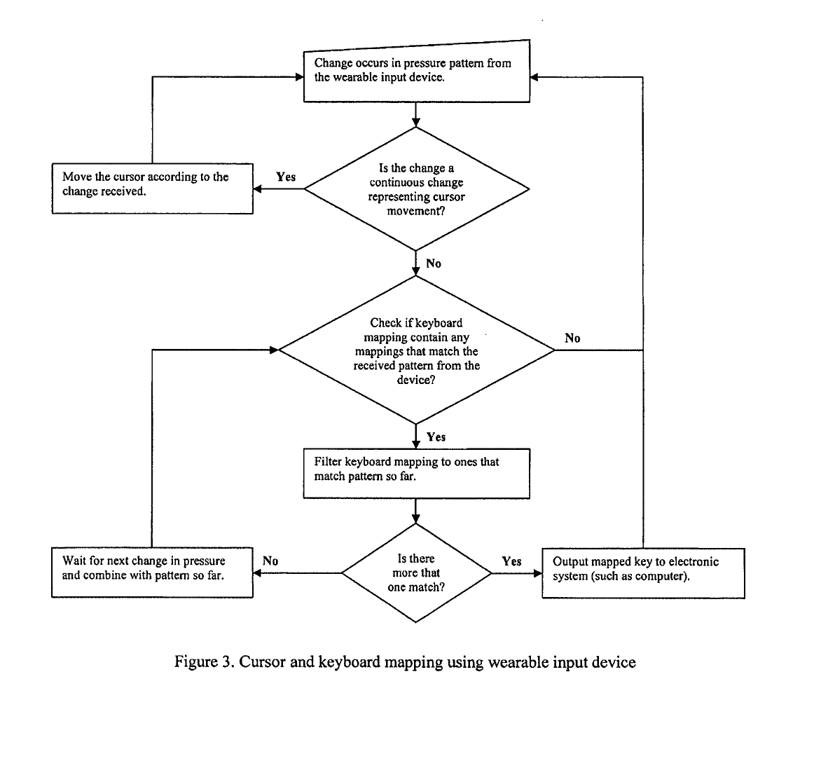

The wearable input device can control cursor movement in least two ways. First, the wearable input device can map pressure or electrical changes, caused by user movement or pattern of movements, to the keyboard or cursor of an electronic system allowing the user to manipulate the electronic system. This process is shown in the flow chart of FIG. 3. Second, the wireless receiver of the wearable input device can be configured with a plurality of sensors arranged in a configuration that allows for calculation of position by triangulation. The relative position of the wearable input device to the receiving sensor can be calculated and mapped to a computer sensor allowing the user of the wearable input device to control a screen cursor. If the user of the wearable input device is, for example, using two wearable input devices, then he can control two screen cursors. Several users of the wearable input device can collaborate to play, for example, a video game.

In the preferred embodiment the wearable input device will provide an interface for one or more memory cards so that security information can be stored and backed up. The memory card(s) can also be utilized as an external hard drive.

In view of the above, it will be seen that various aspects and features of the invention are achieved and other results and advantages can be attained. While preferred embodiments of the invention have been shown and described, it will be obvious to those skilled in the art that changes and modifications may be made therein without departing from the invention in its broader aspects.

It should also be noted that although the wearable input device is claimed and described as having the wearable input device authentication system, cursor or keyboard control, or screen cursor control, the wearable input device can perform any combination of the aforementioned applications. That is, a single wearable input device can have the wearable input device authentication system, cursor or keyboard control and screen cursor control or any combination thereof.

What is claimed:

1. a wearable input device for: (a) receiving/sending and verifying authentication data from/to electronic systems; and (b) providing cursor control and data input on electronic systems comprising:
a means to wirelessly communicate with electronic systems a means to calibrate the wearable input device to at least one user;

2. the wearable input device of claim 1 provides at least one interface for a memory card;

3. the wearable input device of claim 2 is powered by any conventional battery, rechargeable battery system, or other conventional power system;

4. the wearable input device of claim 3 has a means to manually operate the wearable input device;

5. the wearable input device of claim 4 comprises a means to display information regarding the device such as control to provide rudimentary input such as turning power on and off, low battery, wireless connectivity, electronic system requesting authenticate, among others;

6. the wearable input device of claim 5 is worn on any portion of the body where a user has the ability to control body movement;

7. the wearable input device of claim 6 comprises at least one array of sensors arranged to sense pressure changes caused by movement made by user;

8. the wearable input device of claim 6 comprises at least one array of sensors arranged to sense electrical changes caused by movement made by the user;

9. the user of the wearable input device of claim 7 or 8 logs-on by making a movement or pattern of movements enabling the means to wirelessly communicate with electronic systems;

10. the wearable input device of claim 9 comprises a method to authentication electronic systems;

11. the method of claim 10 is configured to be initiated by a movement or pattern of movements caused by the user of the wearable input device

12. the method of claim 10 is configured to be initiated by an electronic system;

13. the method of claim 10 is configured to be initiated automatically;

14. the method of claim 10 is configured to be initiated by manual controls on the wearable input device;

15. the wearable input device of claim 9 comprises a means to authenticate conventional systems by entering a password and username to the conventional authentication system;

16. the wearable input device of claim 15 is configured to activate by a predetermined movement of pattern of movements made by the user;

17. the wearable input device of claim 9 comprises a means to authenticate conventional systems by entering a password into the conventional authentication system;

18. the wearable input device of claim 17 is configured to activate by a predetermined movement or pattern of movements made by the user;

19. the method of claim 17 is configured to be initiated by manual controls on the wearable input device;

20. the wearable input device of claim 9 comprises a means to map pressure or electrical changes to keyboard or cursor input enabling the user to manipulate electronic systems;

21. the wearable input device of claim 20 is configured to activate automatically;

22. the wearable input device of claim 20 is configured to activate by a predetermined movement or pattern of movements made by the user;

23. the wearable input device of claim 9 comprises a means to manipulate a screen cursor.
